(19) United States
(12) Patent Application Publication
(10) Pub. No.: US 2002/0062534 A1
(43) Pub. Date: May 30, 2002

(54) Door hinge cum door checker of vehicles

(76) Inventor: Jeong-Min Seo, Ulsan-shi (KR)

Correspondence Address: CHRISTIE, PARKER & HALE, LLP, 350 WEST COLORADO BOULEVARD, SUITE 500, PASADENA, CA, 91105, US

(21) Appl. No.: 09/991,204

(22) Filed: Nov. 20, 2001

(30) Foreign Application Priority Data
Nov. 24, 2000 (KR) 2000-70383

(51) Int. Cl. E05D 11/10

(52) U.S. Cl. 16/334

(57) ABSTRACT

A door hinge cum door checker of vehicles, wherein a stopper and a hinge pin are integrally formed at a fixation arm mounted to a body while a rotary arm mounted to the door is disposed with a rotary arm mounted to the door is disposed with a roller insertedly accommodated into first/second hole and of the hinge pin by resilient member and a hitching jaw where the stopper is hitched, such that the present invention performs the function of door hinge with the rotary arm rotating about the hinge pin and performs the function of door checker in as much as the roller is received by the first groove or the second grove in response to opened degree of the door while the stopper is hitched by the hitching jaw when the door is fully opened, thereby eliminating the necessity of separate door checker to achieve an effect of reduced number of assembling processes and decreased manufacturing cost.

### BACKGROUND OF THE INVENTION

1. Field of the Invention

The present invention relates to a door hinge of vehicles, and more particularly to a door hinge cum door checker of vehicles adapted to serve as door checker eliminating the necessity of installing a separate door checker.

2. Description of the Prior Art

In general, a door 110 of a vehicle is attached to a body 120 at an upper part and at a lower part via door hinges 130 for opening and closing, and is installed at a midsection with a door checker 140 to enable to keep the door 110 to stay at an opened state at a predetermined position, as illustrated in FIG. 1.

As illustrated in FIG. 2, a body member 131 and a door member 132 are coupled via a hinge pin 133 where, the body member 131 and flange 132a of the door member 132 are formed with coupling holes 131a and 132b through which the body 120 and the door 110 are installed via each bolt.

The door checker 140 includes a hinge bracket 141 mounted at the body 120, a checker bar 142 hinged to the hinge bracket 141 and a checker body 143 mounted at the door 110 for accommodating the other part of the checker bar 142 lest it should be loosened, where the checker bar 142 is formed with a groove 142b, as illustrated in FIG. 3.

When the door 110 is rotated about the hinge pin 133, the checker body 143 is moved to the left and to the right on the checker bar 142, where a roller (not shown) in the checker body 143 is moved when the door 110 is opened from a position near an approximate area 142a of the hinge bracket 141 while the door is closed, thereby positioning itself at the groove 142b.

The roller is pushed toward the checker bar 142 by support means (by way of example, a spring) mounted inside the checker body 143, such that the door 110 where external force is not applied maintains the opened state at a position thereof when accommodated at the groove 142b.

The door hinge 130 and the door checker 140, each mounted in between the body 120 and the door 110, are rotated, closed and opened in a state where the door 110 is installed at the body 120, and serve to perform a function of maintaining the door 110 to be at the opened state at a predetermined position.

However, there is a problem in that, even though the door hinge 130 and the door checker 140 are all mounted between the body 120 and the door 110, and are actuated by the same cause of opening/closing operation by the door 110, the number of assembling process is increased due to their being separated items, and assembling cost thereof is also raised.

### SUMMARY OF THE INVNETION

The present invention is disclosed to solve the aforementioned problems and it is an object of the present invention to provide a door hinge cum door checker of vehicles adapted to enable to perform two functions of door checker and door hinge by one part thereby reducing the number of parts and assembling processes and decreasing costs thereof.

In accordance with the object of the present invention, there is provided a door hinge cum door checker of vehicles, wherein the door hinge cum door checker comprises:

a fixation arm having a round body formed at a mounting plate formed with a mounting hole for mounting to a body while the round body is formed at a tip end thereof with a stopper, a hinge pin formed through the round body and the hinge pin formed with a first groove and a second groove;

a rotary arm having an upper arm and a lower arm, each inserted into the hinge pin and each having a steel roller received by the first and second groove of the hinge pin in response to rotating state of a door, and a coupling plate for coupling the upper arm and the lower arm, where mounting holes are formed at the upper/lower arms and at the coupling plate for mounting to the door, while the upper/lower arms are formed at a connecting body thereof with a hitching jaw at which the stopper of the fixation arm is hitched; and

a cap for respectively covering the upper arm and the lower arm of the rotary arm.

### BRIEF DESCRIPTION OF THE DRAWINGS

For fuller understanding of the nature and objects of the invention, reference should be made to the following detailed description taken in conjunction with the accompanying drawings in which:

FIG. 1 is a schematic drawing for illustrating how a door of a vehicle is mounted;

FIG. 2 is a perspective view of a door hinge;

FIG. 3 is a perspective view of a door checker;

FIG. 4 are plan and front view of body member of a door checker cum door hinge of vehicles according to the present invention;

FIG. 5 are frontal plan view, plan sectional view and right side view of the door checker cum door hinge of vehicles according to the present invention; and

FIG. 6 is a schematic draw illustrating how the door checker cum door hinge is assembled according to the present invention.

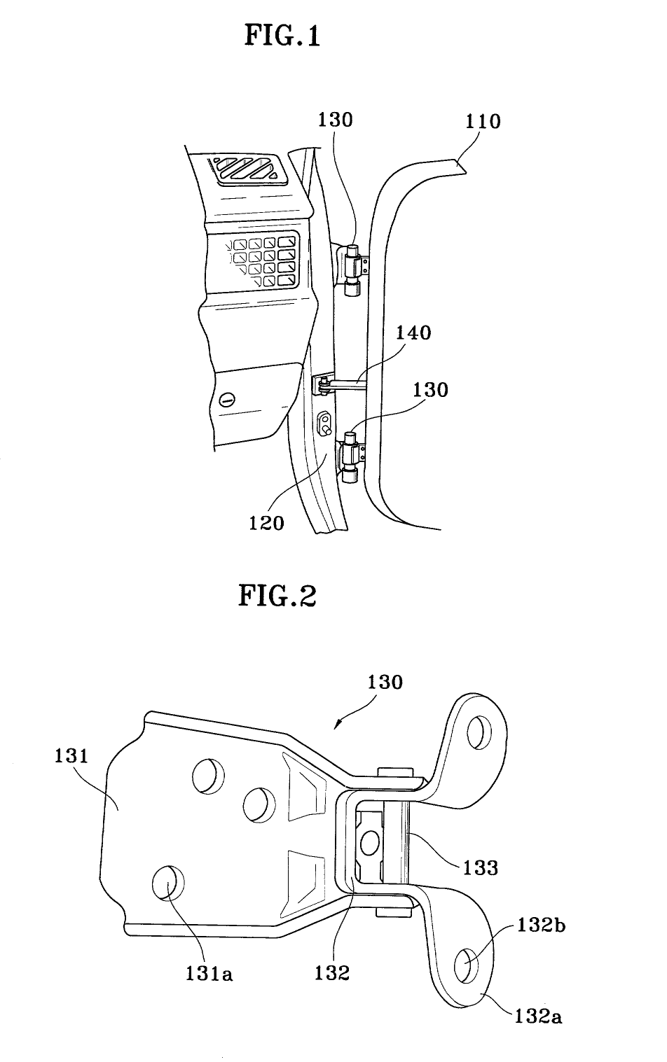

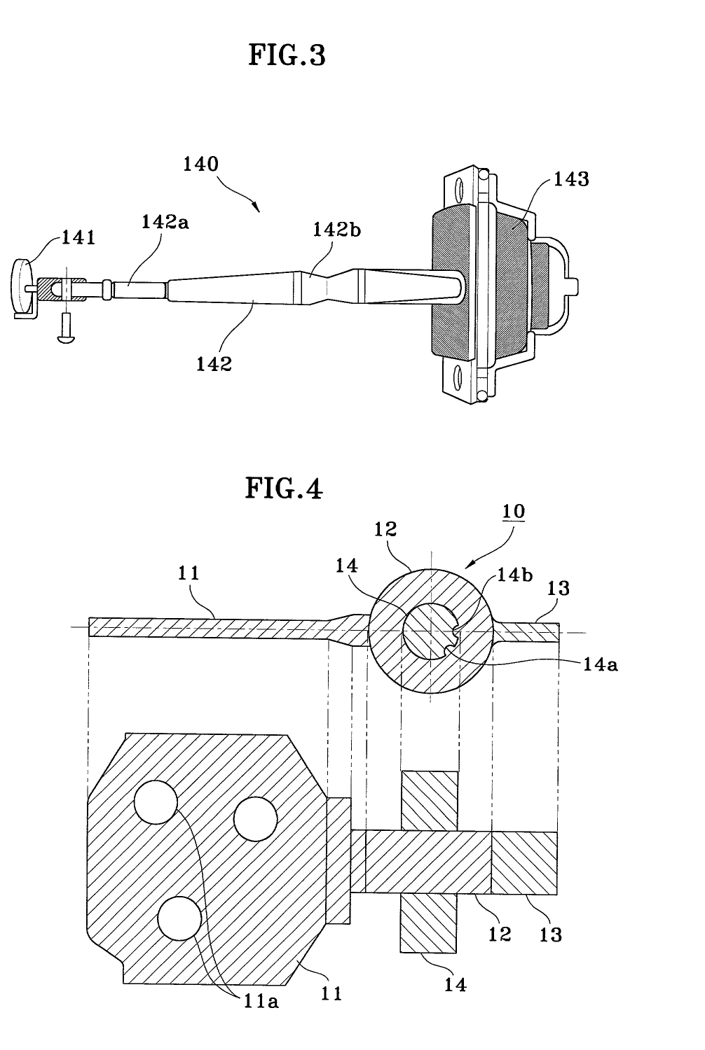

### DETAILED DESCRIPTION OF THE INVENTION

Now, preferred embodiment of the present invention will be described in detail with reference to the accompanying drawings.

The present invention, as mentioned in the foregoing, includes a fixation arm mounted to a body, a rotary arm rotatively connected to the fixation arm and mounted to a door, and a cap for covering a connected part between the rotary arm and the fixation arm.

In other words, as illustrated in FIG. 4, the fixation arm 10 is formed with three mounting holes 11a on a flat-plated mounting plate 11 while the mounting plate 11 is integrally formed with a round body 12.

The round body 12 is defined at upper and lower surfaces thereof with a hinge pin 14 while the hinge pin 14 is formed with a second groove 14b at an opposite side of a same line with the mounting plate 11 and a first groove 14a is formed at a predetermined interval from the second groove 14b. Meanwhile the round body 12 is formed with a stopper 13 of flattened square protruding piece on a same line with the mounting plate 11.

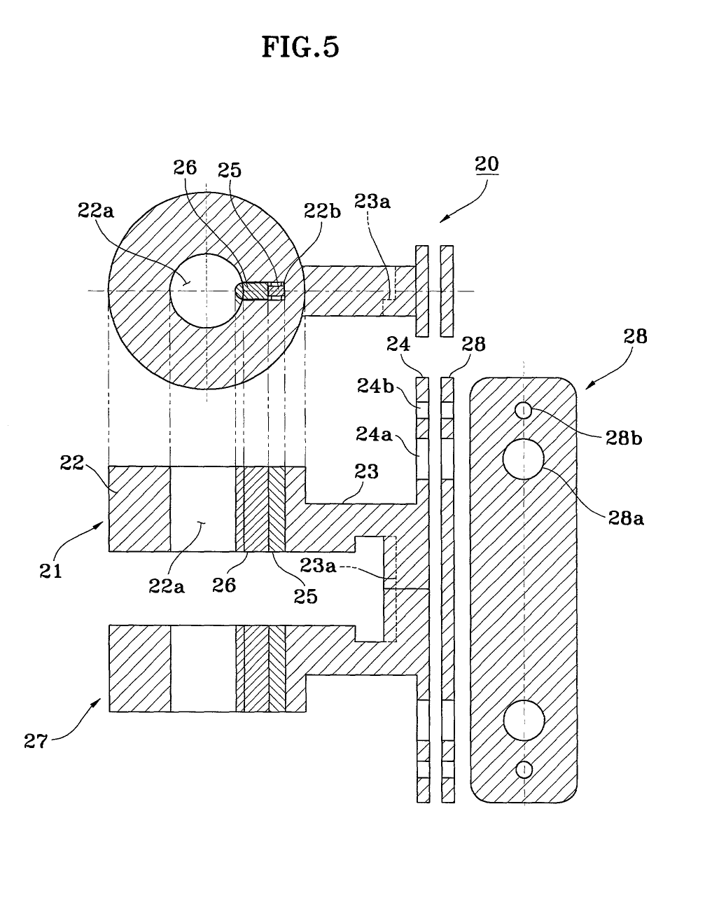

Furthermore, as illustrated in FIG. 5, the rotary arm 20 includes an upper arm 21, a lower arm 27 and a coupling plate 28 for coupling the upper and lower arm 21 and 27, where the upper arm 21 and the lower arm 27 are the same in shapes and constructions therebetween, such that only the upper arm 21 while be described.

The upper arm 21 includes a round body 22 formed with an insertion hole 22a through which a hinge pin 14 is inserted, a connection body 23 extended from one side of the round body 22 and a mounting plate 24 perpendicularly extended from the connection body 23.

The round body 22 is formed with a mounting groove 22b toward the connection body 23 away from the wall side thereof and a roller supported by resilient member 25 such as spring, rubber of the like is installed in the mounting groove 22b. The connection body 23 is defined by a hitching jaw 23a toward the rear side thereof while the mounting plate 24 is disposed with an mounting hole 24b for a large bolt and a coupling hole 24 for a small bolt.

Meanwhile, the coupling plate 28 is an approximate square plate combining the shapes and areas of the mounting plate 24 at the upper arm 21 and the mounting plate at the lower arm 27, where same size of mounting hole 28a and a coupling hole 28b are formed in opposite corresponding positions from the mounting hole and the coupling hole formed at the coupling plate.

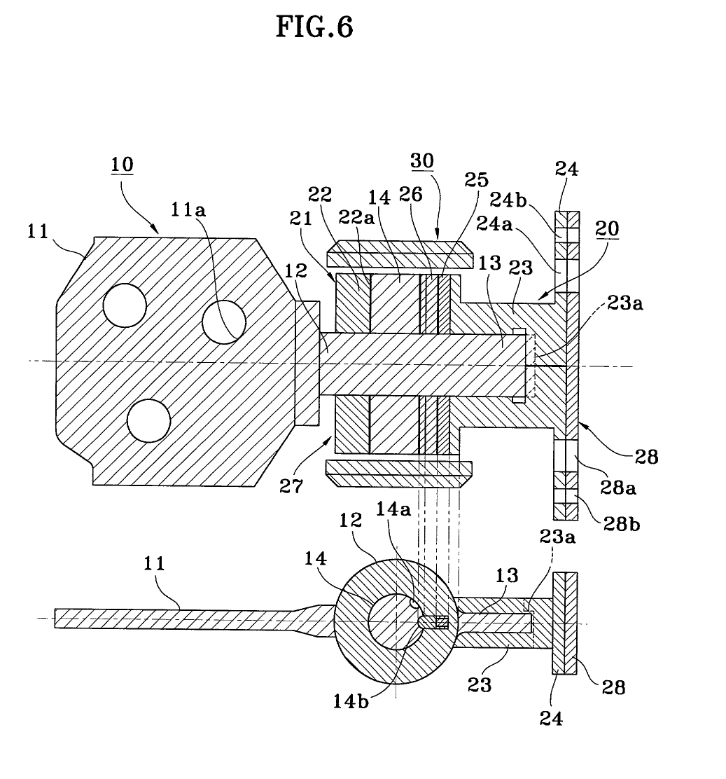

Now, as illustrated in FIG. 6, round bodies at the upper arm and the lower arm are respectively installed at upper and lower sides of the hinge pin 14 at the fixation arm 10, by which mounting plates at the upper and lower arm, each adhered at upper and lower side thereof, are abutted by the coupling plate 28 and the fixation arm 10 and the rotary arm 20 are assembled by using bolts and nuts through coupling holes at the mounting plate and the coupling plate.

The assembly is complete when a cap 30 is installed for preventing raindrops, dust or the like from penetrating the upper side of the upper arm 21 and the lower side of the lower arm 27, which is a joint area between the fixation arm 10 and the rotary arm 20.

In the assembled state thus described, when the mounting plate 11 at the fixation arm 10 is secured to the body, and the mounting plate of the rotary arm 20 and coupling plate 28 are mounted to the door, a whole installation of the door hinge cum door checker of vehicles according to the present invention is completed.

Now, operations of the present invention are described. In the door hinge cum door checker of vehicles thus constructed according to the present invention, the round hinge pin 14 is inserted through the round insertion hole 22a at the upper/lower arm to enable the rotary arm 20 to be rotatively moved on the fixation arm 10, such that the function of door hinge capable of opening and closing the door can be normally performed.

Meanwhile, FIG. 6 illustrates a state where the door is fully opened, where the roller 26 of the rotary arm 20 in the fully opened state of the door is pushed by the resilient member 25 to be received by the second groove 14b formed at the hinge pin 14 of the fixation arm 10. At this time, the stopper 13 at the fixation arm 10 is hitched by the hitching jaw 23a at the rotary arm 20. As a result thereof, the door is no longer opened.

Meanwhile, when the door is to be closed, the rotary arm 20 is rotated counterclockwise, such that when the roller 26 is accommodated in the first groove 14a of the hinge pin 14 while the rotary arm 20 is rotated counterclockwise, the door is no longer closed or opened at this position, enabling to be opened at a predetermined state.

Successively, when the door is rotated to a direction described by a user, the roller 26 is pressed down by the surface of the hinge pin 14 to compress the resilient member 25 and to be inserted into the mounting groove 22b, where the door maintains the fully closed state because striker is held by a door latch.

Meanwhile, when the door is opened, operation in the reversed order occurs. In other words, when the roller 26 is hitched by the first groove 14a, the door is made to maintain an opened state at a predetermined level, and if the door is further opened, the roller 26 is received by the second groove 14b and the stopper 13 at the fixation arm 10 is hitched by the hitching jaw 23a at the rotary arm 20 such that the door is no longer opened and keeps maintaining the opened state as it is. In other words, the door hinge performs the function of door checker is response to inter-operation between the first/second groove 14a and 14b at the fixation arm 10 and the roller 26 formed at the rotary arm 20.

As apparent from the foregoing, there is an advantage in the door hinge cum door checker of vehicles according to the present invention thus described in that the door hinge can simultaneously perform the function of door checker, and only two door hinges are needed to be installed at upper and lower parts of the door, thereby eliminating the necessity of separate erstwhile installation of door checker, reducing the number of parts and manufacturing processes for improvement of work efficiency.

What is claimed is:

1. A door hinge cum door checker of vehicles, the door hinge having a fixation arm mounted to a body of a vehicle, a rotary arm mounted to a door and a hinge pin rotatively connection the rotary arm relative to the fixation arm, wherein the fixation arm is integrally formed with the hinge pin disposed with a firs groove and a second groove and a stopper, while the rotary arm is formed at a roller insertedly accommodated into the first groove and the second groove of the hinge pin in response to opened degree of the door and a hitching jaw where the stopper is hitched, thereby performing the function of a door checker.

2. The door hinge cum door checker of vehicles as defined in claim 1, wherein the fixation arm is disposed with a round body formed at a mounting plate having a mounting hole, and the round body is formed thereabove and thereunder with the hinge pin includes a first groove where the roller is received when the door is half-opened and a second groove where the roller is accommodated when the door is fully opened, and a stopper of flatted square protruding piece is formed at an opposite side of the mounting plate at the round body.

3. The door hinge cum door checker of vehicles as defined in claim 1, wherein the rotary arm comprises:
an upper arm having a mounting groove inside an insertion hole at the round body rotated by being inserted into the hinge pin of the fixation arm, where the roller resiliently supported by a resilient member is disposed at the mounting groove, and the hitching jaw where the stopper of fixation arm is hitched is formed at a connecting body extensively formed from the round body;
a lower arm having a same shape and construction as those of the upper arm and being inserted into the hinge pin underneath the fixation arm; and
a coupling plate for being coupled to mounting plates while the upper arm and the lower arm are respectively inserted by upper/lower hinge pins and for coupling the upper arm and the lower arm.

4. The door hinge cum door checker of vehicles an defined in claim 3, there are formed between the mounting plates of upper arm and the lower arm and the coupling plate coupling holes each of small diameter for inter-coupling therebetween while mounting holes each of large diameter are formed for coupling to the door.

5. The door hinge cum door checker of vehicles as defined in claim 1, wherein the fixation arm and the rotary arm are covered at a joint area thereof by a cap.
